(19) United States
(12) Patent Application Publication
(10) Pub. No.: US 2019/0283137 A1
(43) Pub. Date: Sep. 19, 2019

(54) METALLOPOLYMERS FOR ADDITIVE MANUFACTURING OF METAL FOAMS

(71) Applicant: Lawrence Livermore National Security, LLC, Livermore, CA (US)

(72) Inventor: William Compel, Oakland, CA (US)

(21) Appl. No.: 15/921,360

(22) Filed: Mar. 14, 2018

(51) Int. Cl. B22F 3/11; B22F 1/00; B33Y 10/00; B33Y 80/00; B33Y 70/00; B29C 64/188; C08G 79/00; B01J 39/19

(52) U.S. Cl. CPC B22F 3/1143; B22F 1/0018; B33Y 10/00; B33Y 80/00; B33Y 70/00; B22F 2301/10; C08G 79/00; B01J 39/19; B22F 2304/05; B22F 2301/255; B29C 64/188

(57) ABSTRACT

According to one embodiment, a method of forming a metal foam with substantially uniform density includes forming a metallopolymer network including metallopolymer material with pre-defined ionic conductivity and pre-defined polymeric chain length, adding a reductant to the metallopolymer network during formation thereof for creating metal nanoparticles in the metallopolymer network, where the metal nanoparticles have substantially uniform size, and heating the reduced metallopolymer network for sintering the metal nanoparticles into a network.

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to additive manufacturing of metal foams, and more particularly, this invention relates to metallopolymers for additive manufacturing of metal foams and methods of making same.

### BACKGROUND

Additive manufacturing of metal-containing material has been challenging and expensive. A current method of additive manufacturing includes heating a metal to a liquid, extruding the liquid metal into a pattern, and then, the patterned liquid metal cools to a patterned solid metal. This method, however, involves continual high temperatures to maintain the metal as a liquid during the additive manufacturing process, and thus, lacks efficiency. Another applied manufacturing method to form metal-containing material involves projecting a laser beam onto a bed of metal powder to melt the metal powder or sinter the metal powder together. Subsequent layers are added by adding more powder followed by laser beam treatment to make the metal-containing material. This method, however, generates waste which is not recoverable. Both of these current methods of applied manufacturing of metal-containing material generate waste and use high levels of energy.

It would be desirable to develop a method of additive manufacturing to create a metal material that does not generate waste or use high levels of energy to process.

### SUMMARY

According to one embodiment, a method of forming a metal foam with substantially uniform density includes forming a metallopolymer network including metallopolymer material with pre-defined ionic conductivity and pre-defined polymeric chain length, adding a reductant to the metallopolymer network during formation thereof for creating metal nanoparticles in the metallopolymer network, where the metal nanoparticles have substantially uniform size, and heating the reduced metallopolymer network for sintering the metal nanoparticles into a network.

According to another embodiment, a method of forming a metal foam with graded density includes forming a metallopolymer network including metallopolymer material with pre-defined ionic conductivity and pre-defined polymeric chain length, reducing the formed metallopolymer network to form metal nanoparticles therein, wherein the reduced metallopolymer network has a graded size density of metal nanoparticles therein, and heating the reduced metallopolymer network for sintering the metal nanoparticles into a network.

According to yet another embodiment, a metal foam includes a nanoporous metal structure, wherein the nanoporous metal structure has physical characteristics of formation in part by three dimensional printing of an ink.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is a schematic drawing of a metal coordination polymer, according to one embodiment.

FIG. 1B is a schematic drawing of an organic polymer, according to one embodiment.

FIG. 1C is a schematic drawing of a metallopolymer material, according to one embodiment.

FIG. 1D is a schematic drawing of a proposed mechanism of assembly of a metallopolymer structure, according to one embodiment.

FIG. 2 is a flow chart of a method of forming a metal foam with substantially uniform density, according to one embodiment.

FIG. 3A is a schematic drawing of a method to form a sintered metal NP network with larger porosity, according to one embodiment.

FIG. 3B is a schematic drawing of a method to form a sintered metal NP network with smaller porosity, according to one embodiment.

FIG. 4 is a flow chart of a method of forming a metal foam with a graded density, according to one embodiment.

FIG. 5 is a schematic drawing of a method to form a metal foam with a graded density, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses metal foams formed from metallopolymer material and/or related systems and methods. For example, some embodiments described herein provide methods to process metals at a gel phase and then convert the formed metal gel-like structures to pure metal material.

According to one general embodiment, a method of forming a metal foam with substantially uniform density includes forming a metallopolymer network including metallopolymer material with pre-defined ionic conductivity and pre-defined polymeric chain length, adding a reductant to the metallopolymer network during formation thereof for creating metal nanoparticles in the metallopolymer network, where the metal nanoparticles have substantially uniform size, and heating the reduced metallopolymer network for sintering the metal nanoparticles into a network.

According to another general embodiment, a method of forming a metal foam with graded density includes forming a metallopolymer network including metallopolymer material with pre-defined ionic conductivity and pre-defined polymeric chain length, reducing the formed metallopolymer network to form metal nanoparticles therein, wherein the reduced metallopolymer network has a graded size density of metal nanoparticles therein, and heating the reduced metallopolymer network for sintering the metal nanoparticles into a network.

According to yet another general embodiment, a metal foam includes a nanoporous metal structure, wherein the nanoporous metal structure has physical characteristics of formation in part by three dimensional printing of an ink.

A list of acronyms used in the description is provided below.
3D Three dimensional
AIMD Ab-Initio Molecular Dynamics
Ag Silver
Au Gold
BET Brunauer-Emmett-Teller theory
Cu Copper
DIW Direct ink write
DSC Differential scanning calorimetry
EM Electron microscopy
HED High energy density
Na Sodium
NPs nanoparticles
NIF National Ignition Facility
PAGE Polyacrylamide gel electrophoresis
TGA Thermogravimetric analysis

It will be appreciated that the compounds of various embodiments can contain asymmetrically substituted atoms, such as asymmetrically substituted carbon atoms, asymmetrically substituted sulfur atoms, asymmetrically substituted metal atoms, or any combination thereof. All chiral, diastereomeric, racemic forms and all geometric isomeric forms of a structure are part of this disclosure. For example, a metallopolymer composition can comprise an (R)-cysteine substituent, and (S)-cysteine substituent, or both.

As used herein, a “thiol” refers to an organic compound that includes at least one “—SH” group, which is typically a primary or secondary thiol group, and which can be used as a coinage metal ligand. The thiol can be a water-soluble thiol or organic-soluble thiol. Preferably, the thiol molecule also includes a carboxylic acid or amine moiety.

Examples of suitable water-soluble thiols include, but are not limited to, glutathione, cysteine, captopril, thiomalic acid (mercaptosuccinic acid), N-(2-mercaptopropionyl)glycine, p-mercaptobenzoic acid, m-mercaptobenzoic acid, penicillamine, (C₂-C₇)mercaptoalkanoic acids such as 6-mercaptohexanoic acid, and the like.

Examples of suitable organo-soluble thiols include, but are not limited to, 2-phenylethanethiol (PET), 1-phenylethanethiol, benzyl mercaptan, thiophenol, (C₁-C₁₈)alkylthiols such as methanethiol, isopropyl thiol, t-butyl thiol, hexanethiol and dodecanethiol, (C₈-C₁₈)mercaptoalkanoic acids such as 11-mercaptoundecanoic acid, (C₃-C₈)mercaptocycloalkanes such as cyclohexanethiol, dimercaptosuccinic acid, 2-mercaptoethanol, 3-mercaptopropanol, 3-mercaptopropane-1,2-diol (2,3-dihydroxypropyl-mercaptan; thioglycerol), 1-adamantanethiol, 1-naphthalenethiol, 2-naphthalenethiol, camphorthiol, and the like. Some organo-soluble thiols such as those having a carboxylic acid functionality may become water soluble at high pH (e.g., above about 7, above about 7.5, or above about 8). Organo-soluble thiol derivatives having carboxy or amino functionalities related to the thiols of this paragraph are commercially available or can be prepared synthetically, for use as the thiols of the compositions described herein.

Thiolates typically comprise about 1-30 carbon atoms and may have a wide variety of functional or substituent groups such as oxo (e.g., carbonyl, aldehyde, or ketone) moieties, carboxylic acids, anhydride moieties, ester moieties, amide moieties, cyano, nitro, inorganic acid derivatives (e.g., phospho and boro acids and derivatives) and their sulfur and amino analogs, including I °, II °, III °, and IV ° amines, zwitterionic moieties, and various substituents where the substituents may be hydrocarbon or substituted hydrocarbon, as well as carbocyclic and heterocyclic, with functional groups coming within the groups set forth above, as well as nitrogen derivatives, such as azo, azoxy, and diazo, organic and inorganic salts of the above ions, and the like. Complex thiolates may be used, both naturally occurring and synthetic, including oligomers, e.g., oligopeptides, of from about 2 to 30 units, thio analogs of purines, pyrimidines, nucleotides and nucleosides, aptamers, and amide linked nucleic acid analogs.

As used herein, the term “glyme” refers to a glycol ether. One representative example is dimethoxyethane. “Diglyme” refers to diethylene glycol dimethyl ether. Additional glymes include triglyme (triethylene glycol dimethyl ether) and tetraglyme (tetraethylene glycol dimethyl ether).

Glycol ethers can have, for example, a hydroxyl group, an alkyl group, or an ester group as a terminal group, while the other terminal group is typically an alky or phenyl group, but can also be a hydroxyl group. Glymes further include polyethylene glycols of various lengths.

Various embodiments described herein combine organic and inorganic components at a molecular level to allow metals to be processed like plastics. Furthermore, methods using these materials are advantageous in additive manufacturing because the methods enable low-cost and rapid manufacturing of entire functional devices that depend on a metal structure.

Various embodiments described herein include metallopolymer materials that may be synthesized in various forms, such as, but not limited to a gel, dried to a powder, cast into a mold, deposited as a thin film, extruded into a three dimensional (3D) structure, etc. and may retain unique metallic behavior such as fluorescence, conductivity, catalytic activity, anti-microbial activity, etc.

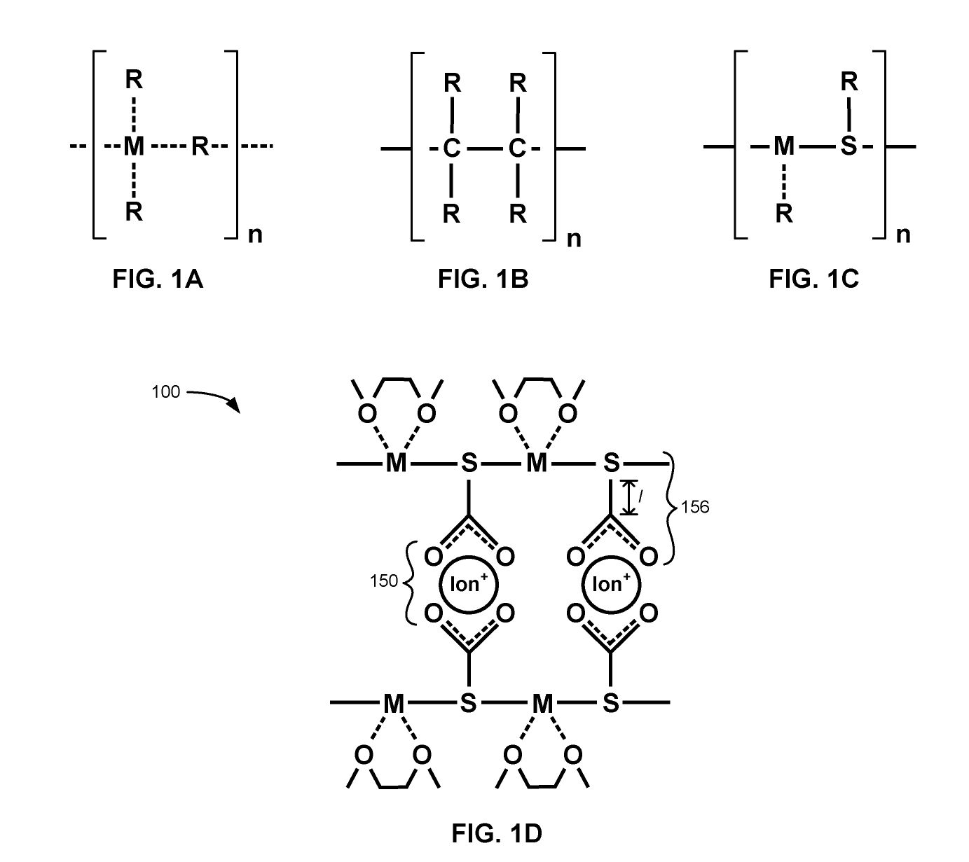

Various embodiments described herein use methodology disclosed in U.S. patent application Ser. No. 15/368,232 which is herein incorporated by reference. In brief, the methodology describes a process for creating a metallopolymer material (FIG. 1C) that includes metal coordination polymers (FIG. 1A) where M is a metal with physically bound side chains of polymers coordinated with M. The metallopolymer material also includes organic polymers (FIG. 1B) with covalently bound side chains. The metallopolymer material may have the processing capability of polymers while maintaining metallic characteristics.

In one embodiment, the metallopolymer material has a molecular structure that includes a metal-thiolate backbone (-M-S—, FIG. 1C) with covalently bound side chains (solid line, S—R) and physically bound side chains (dashed line, M - - - R). The covalently bound side chains may provide adaptability for adjustable static properties much like organic polymers, e.g. varying chain length, varying chain flexibility, etc. The physically bound side chains may enable a dynamic bonding environment that renders the material environmentally responsive, e.g. the material possess correct rheology for shear thinning, define bulk material stiffness, etc. Without wishing to be bound by any theory, it is believed that the physically bound side chains may serve as built-in plasticizer to modulate the structural rigidity of a functional metallopolymer.

FIG. 1D depicts a schematic representation of a mechanism to create a metallopolymer material 100 that includes ionic bridges 150 and pre-defined polymeric chain length of the thiol ligand 156. According to one embodiment, the metallopolymer segments may perform like plasticizers, as depicted in FIG. 1D, with oxygen O atoms forming physical bonds with the metal M atoms of the M-S backbone thereby bolstering one side of the metallopolymer segments; and on the other side of the metallopolymer segments, the thiol ligands 156 provide a site for ionic assembly, as shown with association with sodium ions (Na⁺). Furthermore, the length and flexibility of the covalently bound polymeric chain of the thiol ligand 156 may also affect the ionic conductivity of the ionic bridge 150.

In various embodiments, the ionic conductivity of the metallopolymer material may be tuned based on two factors as shown in FIG. 1D: the strength of the ionic bridge 150 interaction and the flexibility of the polymeric chain of the thiol ligands 156. These two factors may be independently assessed by controlling chemical identity, chain length, and rigidity of the metallopolymer network in silico, i.e., by computer simulation, as discussed further below. In various embodiments described herein, the tunable ionic conductivity of the metallopolymer material may translate into pre-determined tunable ionic conductivity of metal foam formed from the metallopolymer material.

According to one embodiment, the metallopolymer network formed with metallopolymer material may exhibit unique behavior such as ionic conductivity and remarkably high storage modulus that is higher than the sum of the component properties (metal coordination polymers in FIG. 1A and organic polymers in FIG. 1B).

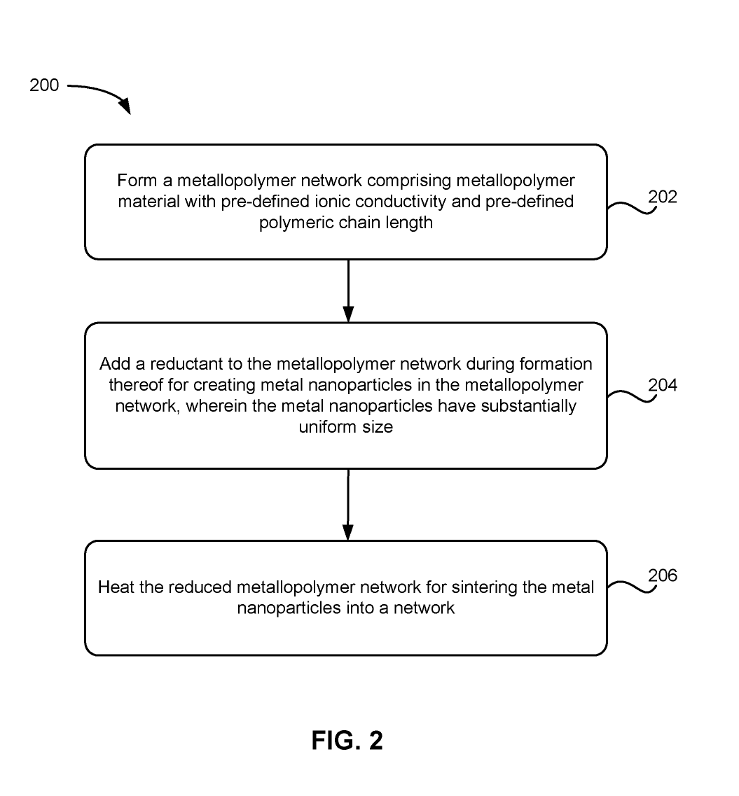

FIG. 2 shows a method 200 for forming a metal foam with substantially uniform density, in accordance with one embodiment. As an option, the present method 200 may be implemented to structures such as those shown in the other FIGS. described herein. Of course, however, this method 200 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 2 may be included in method 200, according to various embodiments. It should also be noted that any of the aforementioned features may be used in any of the embodiments described in accordance with the various methods.

FIG. 2 graphically depicts steps in a method 200 of forming a metal foam with substantially uniform density. In some approaches, the method may form metal foams with substantially uniform density, for example, but not limited metal foams of Au, Ag, copper (Cu), etc. with substantially uniform density. The method begins with step 202 involving forming a metallopolymer network including metallopolymer material with pre-defined ionic conductivity and pre-defined average polymeric chain length. The metallopolymer material may include a metal, a thiol, and a glyme.

In an exemplary approach, a ratio of the thiol to the metal at a same concentration may be at least three % vol thiol to 1% vol metal. In various approaches, the ratio of thiol to metal may be a molar ratio of 1 metal to 3 thiol.

In various approaches, the metal may be a coinage metal. For example, but not intended to be limiting, the coinage metal may be Au, Ag, Cu, etc. In some approaches, the metal may be a combination of metals. For example, but not intended to be limiting, the metal may be a combination of coinage metals.

In some approaches, the metal may be tin, platinum, palladium, titanium, aluminum, etc.

In various approaches, the glyme may be defined as a glycol ether, a glycol diether, and any version thereof as described in the beginning of this section. In a preferred approach, a volume ratio may be 1 unit metal (100 mM) to 6 units glyme (pure) may depend on the molecular weight of each glyme. In some approaches, the glyme may be in the range of about 100 to about 200 equivalents of polyethylene glycol dimethyl ether (glyme) to one equivalent of metal. The concentration of pure glyme, for example mono-, di- tri-, tetra-, pentaglyme, etc., may depend on the molecular weight of the glymes.

Looking back to FIG. 1D, in some approaches, the ionic conductivity may be tuned by the strength of an ionic bridge 150 formed between two polymeric side chains of opposing thiol ligands 156 in a metallopolymer material 100. In some approaches, the ionic conductivity may be tuned by varying the length l of the polymeric side chain length of the thiol ligand 156. In some approaches, the ionic conductivity may be tuned by varying the flexibility of the polymeric side chain of the thiol ligand 156. In some approaches, the ionic conductivity may be tuned by the strength of the ionic bridge 150 interaction. In some approaches, determinations of polymeric side chain length of the thiol ligands 156 and ionic bridge 150 interaction may involve performing Ab-Initio Molecular Dynamic (AIMD) simulations of lithium (Li⁺) and sodium (Na⁺) ion conductivity in which ab initio methods provide simulations of breaking or formation of covalent bonds and the electronic states associated with functions. In some approaches, any cation may be substituted, for example, but not limited to, potassium (K⁺), calcium (Ca²⁺), ammonium (NH₄⁺), etc.

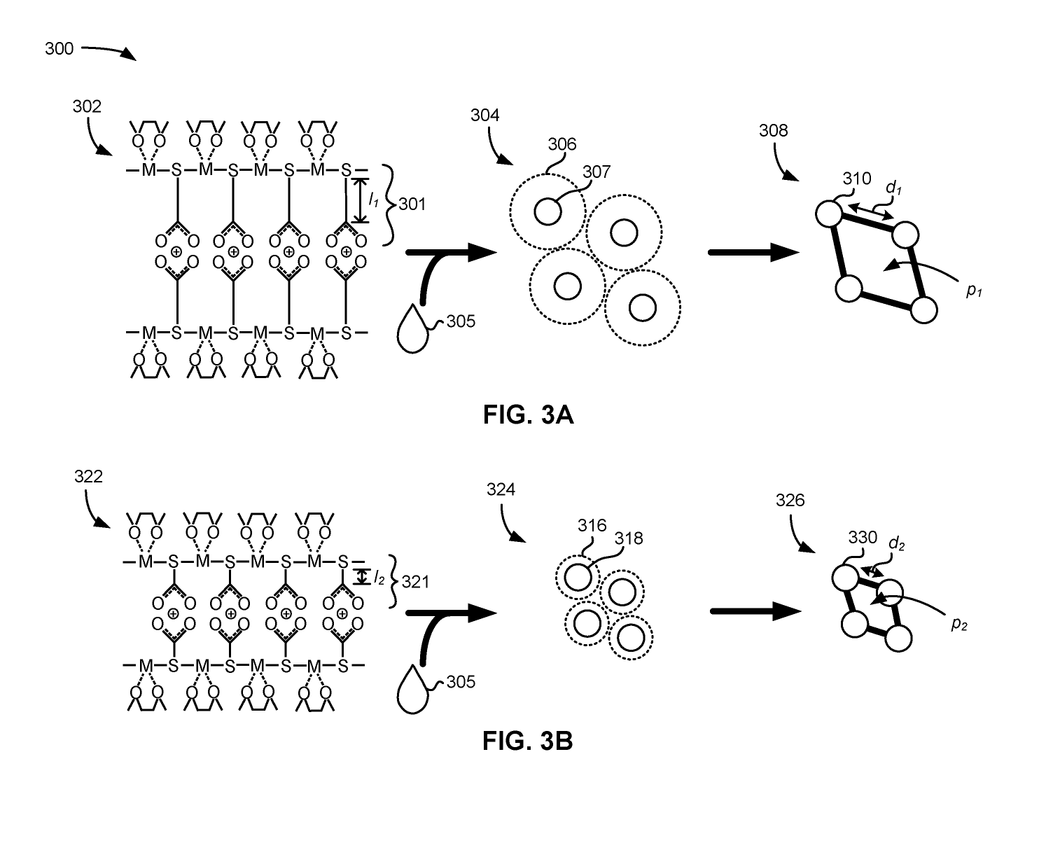

In some approaches, the average polymer side chain length l may be defined by adjusting pH. In other approaches, thiols may be purchased with various polymer side chain length l of the thiol ligands 156 and used for creating the metallopolymer material 100. In some approaches, a length l of the average polymeric side chain of the thiol may determine the nanoparticle spacing in the reduced metallopolymer network, and subsequently the distance d₁ between the nanoparticle remnants 310 in sintered metal foam 308 (FIG. 3A) and distance d₂ between the nanoparticle remnants 330 in sintered metal foam 326 (FIG. 3B). Thus, in turn, the porosity of the final sintered structure may be controlled by the length of the average polymeric side chain.

In some approaches, the thiol of the metallopolymer material may be glutathione. In other approaches, the thiol of the metallopolymer material may be cysteine. In yet other approaches, the thiol of the metallopolymer material may be thiomalic acid.

Step 204 includes adding a reductant to the metallopolymer network during formation thereof for creating metal nanoparticles in the metallopolymer network. Further, the metal nanoparticles in the metallopolymer network may have substantially uniform size (e.g., average diameters within 5% of the median diameter). In some approaches, step 204 may include controlling a concentration of a reductant to result in a particular diameter of metal nanoparticles in the reduced metallopolymer network.

The printed metallopolymer network by applied manufacturing may be a printed three dimensional (3D) structure. In some approaches, the metallopolymer ink may be extruded through a nozzle using a Direct Ink Writing (DIW) method of applied manufacturing to form a metallopolymer network. In other approaches, the metallopolymer ink may be printed using projection microstereolithography to form a metallopolymer network.

The metallopolymer material as shown in FIG. 1D may be used as an ink without additives to optimize rheology for DIW fabrication. The nature of the weak physically bound side chains coordinated to the M of the metal-thiolate backbone (-M-S—) allows shear thinning and the flexibility and length of the covalently bound side chains of the thiol ligand 156 controls bulk material stiffness. Furthermore, these features may function as a built-in plasticizer in the metallopolymer material and provide optimal modular rheology for applied manufacturing processes.

According to method 200 of forming a metal foam with substantially uniform density, step 204 may involve simultaneous reduction of the forming metallopolymer network to a network of substantially uniform metal nanoparticles (NPs). In some approaches, step 204 may involve forming a metallopolymer network in the presence of a reductant to reduce the forming metallopolymer network into a reduced metallopolymer network of metal nanoparticles having substantially uniform size. In some approaches, the reductant may be added to the metallopolymer as a mixture for an ink. In other approaches, the reductant may be added as a component during extrusion of the metallopolymer material into a metallopolymer network.

Reduction techniques known by one skilled in the art may be used and optimized for the specific metal of the metallopolymer network. Any suitable reductant may be used that would be apparent to one skilled in the art upon reading the current disclosure. For example, but not meant to be limiting, in some approaches step 204 may involve using a sodium borohydride reductant to reduce the forming gold (Au) metallopolymer network into a metallopolymer network of substantially uniform Au NPs. Another example, that is not meant to be limiting, may include reducing a forming silver (Ag) metallopolymer network into a metallopolymer network of substantially uniform Ag NPs with the reducing effects of laser beam technology known by one skilled in the art.

Step 206 of method 200 includes heating the reduced metallopolymer network for sintering the metal nanoparticles into a network of metal nanoparticles. In some approaches, sintering the metal nanoparticles of the metallopolymer network removes the organic material (e.g. polymer) and melts the metal NPs together into a metal foam. The techniques of sintering the metallopolymer network of metal nanoparticles may involve conventional sintering techniques known by one skilled the art.

FIGS. 3A-3B illustrate a schematic diagram of a method 300 for forming a metal foam with substantially uniform density from a single material, in accordance with one embodiment. As an option, the present method 300 may be implemented to construct structures such as those shown in the other FIGS. described herein. Of course, however, this method 300 and others presented herein may be used to form structures for a wide variety of devices which may or may not be related to the illustrative embodiments listed herein. Further, the processes presented herein may be carried out in any desired environment. Moreover, more or less operations than those shown in FIGS. 3A-3B may be included in method 300, according to various embodiments. It should also be noted that any of the aforementioned features may be used in any of the embodiments described in accordance with the various methods and processes.

According to some embodiments, forming a metal structure with substantially uniform density, e.g. a metal foam, includes forming a metallopolymer network with metallopolymer material including a thiol ligand having a polymeric side chain of pre-defined length in the presence of a reductant. In various approaches, a process of forming a metal structure with uniform density may include a simultaneous addition of a reductant during the formation of a metallopolymer network. FIGS. 3A and 3B illustrate a process as described in method 200 of FIG. 2, such that FIG. 3A illustrates a starting metallopolymer material with a thiol ligand 301 having a polymeric side chain of pre-defined length l₁, and FIG. 3B illustrates a starting metallopolymer material with a thiol ligand 321 having a polymeric side chain of pre-defined length l₂.

FIG. 3A illustrates forming a metal structure with substantially uniform density starting with a metallopolymer material 302 with a thiol ligand 301 having a polymeric side chain of pre-defined length l₁. In various embodiments, the components of the metallopolymer material may be altered to define the structure-property relationships of the metallopolymer material. According to a method 300 similar to the stepwise method 200 in FIG. 2, a reductant 305 may be added simultaneously during formation of the metallopolymer network thereby resulting in a reduced metallopolymer network 304 of nanoparticles having substantially uniform size.

FIG. 3B illustrates forming a metal structure starting with a metallopolymer material 322 with a thiol ligand 321 having a polymer side chain of pre-defined length l₂ that is a different length than l₁ of the polymer side chain of a thiol ligand 301 of the metallopolymer material 302 in FIG. 3A.

As shown in both FIGS. 3A and 3B, adding reductant 305 while forming the metallopolymer network with the metallopolymer material 302, 322 may simultaneously grow metal nanoparticles 307, 318 to a substantially uniform size and trap the nanoparticles 307, 318 in the thiolates 306, 316 of the resulting reduced metallopolymer network 304, 324, according to various embodiments. For example, but not meant to be limiting, reducing a cationic Au in a Au metallopolymer forms a zero-valent Au NP core encapsulated by thiolates. The Au core may continue to grow for as long as the reductant is present in the system. The reduced metallopolymer network 304, 324 may include metal NPs of substantially uniform size.

Following the formation of a reduced metallopolymer network with metal NPs, the method 300 includes sintering the reduced metallopolymer network 304, 324 to form the final sintered metal foam 308, 326 with fine control of porosity and density of the metal foams. In some approaches, the temperature for sintering the reduced metallopolymer network may be at an effective temperature to remove organic material of the network and to coalesce the particles in the network to a metal foam. In some approaches, the temperature for sintering may be in a range of about 150° C. to about 300° C.

In FIG. 3A, sintering the reduced metallopolymer network 304 may result in a sintered metal foam 308 having substantially uniform porosity with an average pore size p₁ that may be defined from the sintered remnants 310 of the metal nanoparticles 307 and a distance d₁ between the sintered remnants 310. Moreover, the distance d₁ between the sintered remnants 310 may correspond to a relative length l₁ of the polymeric side chain of the thiol ligand 301 of the starting metallopolymer material 302.

Likewise, in FIG. 3B, sintering the reduced metallopolymer network 324 may result in a sintered metal foam 326 having a substantially uniform porosity with an average pore size p₂ that may be defined from the sintered remnants 330 of the metal nanoparticles 318 and a distance d₂ between the sintered remnants 330. Moreover, the distance d₂ between the sintered remnants 330 may correspond to the relative length l₂ of the polymeric side chain of the thiol ligand 321 of the starting metallopolymer material 322.

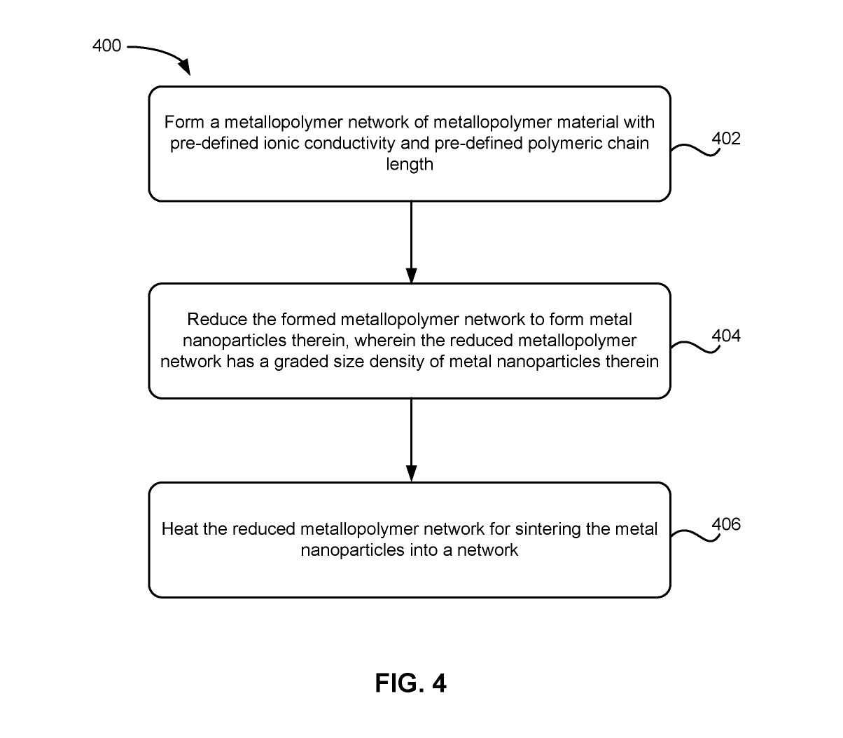

FIG. 4 shows a method 400 for forming a metal foam with graded density, in accordance with one embodiment. As an option, the present method 400 may be implemented to structures such as those shown in the other FIGS. described herein. Of course, however, this method 400 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 4 may be included in method 400, according to various embodiments. It should also be noted that any of the aforementioned features may be used in any of the embodiments described in accordance with the various methods.

In the method 400, a metal foam with graded density may be formed from a metallopolymer network with a gradient of different sizes of metal nanoparticles. In some approaches, the method 400 may form a metal foam with graded density. Method 400 includes a process in which a metallopolymer network is formed from a metallopolymer material, and then a reducing agent is introduced post-formation. In some approaches, the method may form metal foams with graded density, for example, but not limited to metal foams of Au, Ag, Cu, etc. with graded density.

Looking to FIG. 4, method 400 begins with step 402 involving forming a metallopolymer network of metallopolymer material with pre-defined ionic conductivity and pre-defined average polymeric chain length. The metallopolymer material may include a metal, a thiol, and a glyme. In an exemplary approach, a ratio of the thiol to the metal at a same concentration may be at least three % vol thiol to 1% vol metal (e.g. 3:1). Further, a ratio of glyme to a metal of a same concentration may be at least 100% vol glyme to 1% vol metal (e.g. 100:1) In various approaches, the metal may be a coinage metal, for example, but not limited to Au, Ag, Cu, etc. In some approaches, the metal may be a combination of metals, for example, a combination of coinage metals.

In various approaches, the glyme may be defined as a glycol ether, a glycol diether, and any version thereof as described in the beginning of this section. In a preferred approach, the glyme may be in the range of about 100 to about 200 equivalents of polyethylene glycol dimethyl ether (glyme) to one equivalent of metal. The amount of various glymes, for example mono-, di- tri-, tetra-, pentaglyme, etc. may depend on the molecular weight of the glymes.

Looking back to FIG. 1D and as discussed in the above section, in some approaches, the ionic conductivity may be tuned by the strength of an ionic bridge 150 formed between two polymeric side chains of opposing thiol ligands 156 in a metallopolymer material 100.

In some approaches, the metallopolymer network may be formed by printing an ink, where the ink includes the metallopolymer material. Further, the formed metallopolymer network may be a printed three dimensional structure. The printed metallopolymer network may be formed by applied manufacturing. In some approaches, the metallopolymer ink may be extruded through a nozzle using a DIW method of applied manufacturing to form a metallopolymer network. In other approaches, the metallopolymer ink may be printed using projection microstereolithography to form a metallopolymer network.

In some embodiments, the metallopolymer material may form a metallopolymer network that has pre-defined physical properties. In some approaches, the physical property of the formed metallopolymer network may be structural coloration, where structural coloration is defined by the production of color by microscopically structured surfaces fine enough to interfere with visible light. In some approaches, the physical property of the formed metallopolymer network may be that the formed metallopolymer network is electrically conductive.

Step 404 includes reducing the formed metallopolymer network to form metal nanoparticles therein, where the reduced metallopolymer network may have a graded size density of metal nanoparticles therein. In some approaches, reductant is introduced to the surface of the 3D structure of the metallopolymer network and allowed to diffuse slowly through the structure. In so doing, the diffusion of reductant may create a concentration gradient in which higher concentrations of reductant form larger metal nanoparticles. In various approaches, metal nanoparticle size may be tuned along this gradient by varying the reductant concentration.

Reduction techniques known by one skilled in the art may be used and optimized for the specific metal of the metallopolymer network. Any suitable reductant may be used that would be apparent to one skilled in the art upon reading this disclosure. In some approaches, a chemical reductant specific for reducing a particular metal may be introduced to the metallopolymer network. For example, but not meant to be limiting, in some approaches step 404 may involve using a sodium borohydride reductant to reduce the gold (Au) metallopolymer network into a network of Au NPs with graded density. In other approaches, non-chemical techniques may be used as a specific reductant to reduce a particular metal. An example, that is not meant to be limiting, may include reducing a silver (Ag) metallopolymer network into a network of Ag NPs with graded density using laser beam technology known by one skilled in the art.

Various approaches described herein may allow tuning of NP size by varying the reductant concentration. The size distribution of metal NPs in the network may be confirmed using polyacrylamide gel electrophoresis (PAGE) for rapid confirmation of monodispersity and electron microscopy (EM) and dynamic light scattering for quantification of size distribution.

In some approaches, the formed metal nanoparticle network may be electrically conductive.

Step 406 of method 400 includes heating the reduced metallopolymer network for sintering the metal nanoparticles into a network. In some approaches, the sintering techniques of the metal NPs may allow fine control of porosity and density of the metal foams. In some approaches, sintering the metal NP network removes the polymer and melts the metal NPs together into a metal foam. The techniques of sintering the metal nanoparticle network may involve conventional sintering techniques known by one skilled the art.

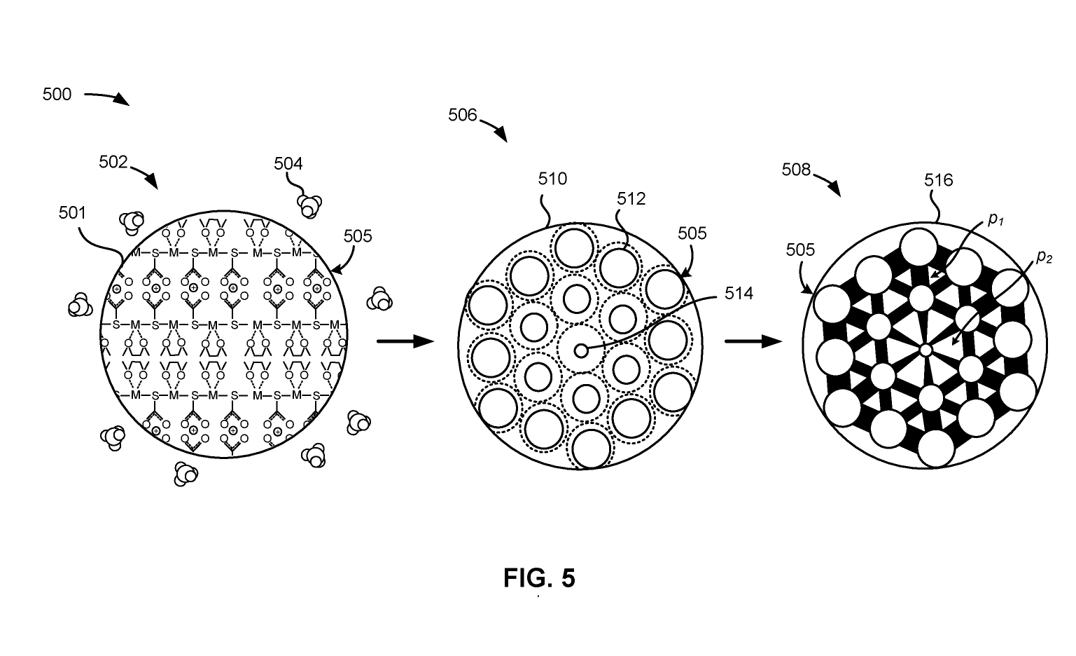

FIG. 5 illustrates a schematic diagram of a method 500 for forming a metal foam with graded density, in accordance with one embodiment. As an option, the present method 500 may be implemented to construct structures such as those shown in the other FIGS. described herein. Of course, however, this method 500 and others presented herein may be used to form structures for a wide variety of devices which may or may not be related to the illustrative embodiments listed herein. Further, the methods presented herein may be carried out in any desired environment. Moreover, more or less operations than those shown in FIG. 5 may be included in method 500, according to various embodiments. It should also be noted that any of the aforementioned features may be used in any of the embodiments described in accordance with the various methods and processes.

According to some embodiments, a process of forming a metal structure with graded density may include forming a metallopolymer network followed by an addition of a reductant to reduce the formed metallopolymer network. In various approaches, the solid metallopolymer material may be reduced post-formation to form a metal NP size gradient in the reduced metallopolymer network. FIG. 5 illustrates the stepwise method 400 shown in FIG. 4. According to one embodiment, step 502 of method 500 includes forming a metallopolymer network 501 from a metallopolymer material. In some approaches, the metallopolymer network may be printed as a 3D structure using applied manufacturing techniques.

Following formation of a structure of the metallopolymer network 501, a reductant 504 may be added to the metallopolymer network 501. In some approaches, the reductant 504 may be introduced at the surface 505 of the metallopolymer network 501 to slowly diffuse through the metallopolymer network. As reductant 504 diffuses through the structure of metallopolymer network 501, the reduced metallopolymer network 510 nucleates and grows metal NPs 512. A concentration gradient of the reductant may form where higher concentrations of reductant nearer the surface 505 of the structure of reduced metallopolymer network 510 may form larger metal NPs 512; and lower concentrations of reductant further from the surface 505 of the structure of the reduced metallopolymer network 510 may form smaller metal NPs 514.

In some approaches, the particle size may be tuned by varying reductant concentration. In some approaches, ion transport properties may be modeled through simulation to provide fine control over reductant diffusion through the material. During the reduction treatment of step 506, the structure of the reduced metallopolymer network 510 may form a structure of a network of NPs 514, 512, etc. with graded size density.

In step 508 the structure of the reduced metallopolymer network 510 of metal NPs 512, 514, etc. may be sintered to form a metal foam 516 with graded density. In some approaches, the metal foam 516 may be characterized by a continuous network. In some approaches, sintering the reduced metallopolymer network 510 may result in a sintered metal foam 516 having a graded density with an average pore size p₁ near the surface 505 that may increase in size to an average pore size p₂ further from the surface where smaller metal nanoparticles 514 formed in the reduced metallopolymer network 510 before sintering.

Conventional methods of sintering may be used to sinter distributed metal NPs 512, 514 into a mesoporous metal foam 516. In some approaches, the mesoporous foam may be an Au foam. The sintering process may include differential scanning calorimetry (DSC) and thermogravimetric analysis (TGA) to determine the temperature at which particles fuse, which may be ca. 150° C., but may be higher or lower.

According to one embodiment, a metal foam includes a nanoporous metal structure, where the metal structure has physical characteristics of formation by three dimensional printing of an ink that includes a metallopolymer material. In some embodiments, the metal foam may have a substantially uniform density throughout, as depicted in structures of sintered metal foam 308, 326 of FIGS. 3A and 3B, respectively. In some approaches, the metal foam may have substantially uniform porosity. In some approaches, the metal foam 308, 326 may have substantially uniform spacing throughout, where the spacing may be defined by metal nanoparticles 307, 318 before sintering the reduced metallopolymer network 304, 324.

In some embodiments, the metal foam may have a graded density as shown in the sintered metal foam 516 in FIG. 5. In some approaches, the metal foam 516 may have a graded density with an average porosity increasing from an outer surface of the metal foam toward an innermost portion thereof.

In some approaches, the metal foam may have nanopores with a diameter of nanometer scale. In one approach, a nanoporous structure may be defined as being microporous, where the diameter of the pores are in a range of about 0.2 nm to about 2 nm. In another approach, a nanoporous structure may be defined as being mesoporous, where the diameter of the pores are in a range of about 2 nm to about 50 nm. In yet another approach, a nanoporous structure may be defined as being macroporous, where the diameter of the pores are in a range of about 50 nm to about 1000 nm. In another approach, a nanoporous structure has nanopores with a diameter of about 0.2 nm to about 100 nm. In yet other approaches, a nanoporous structure may be defined as having a combination of being macroporous, mesoporous, and/or microporous.

The metal foam formed by methods described herein of forming a 3D structure of a metallopolymer network formed from an ink of metallopolymer material may have physical characteristics of formation by 3D printing that includes ridges along one surface of the metal foam characteristic of extrusion from a nozzle. In some approaches, the metal foam may have ridges along one surface of a metal foam with substantially uniform density. In other approaches, the metal foam may have ridges along one surface of a metal foam with graded density.

In some approaches, the continuous network resistance may be verified to reach ca. 1Ω, a value that may be close to the value of bulk metal conductivity, for example bulk Au conductivity.

In some approaches, surface area of the metal foam may be quantified with Brunauer-Emmett-Teller (BET) theory. In other approaches, the porosity of the metal foam may be assed with EM. Parameters of the metal foam, including density and porosity, may be tuned by adjusting the sintering temperature, the duration of heat exposure during sintering, NP core size, thiol chain length, etc. In yet other approaches, parameters of the metal foam may be tuned using more robust chemical sintering techniques.

In some embodiments, the formation of metal foam may include Au, Ag, and Cu systems. In some approaches, the metal foam may be at least 98% pure gold (Au). In other approaches, the metal foam may be at least 98% pure silver (Ag). In yet other approaches, the metal foam may be at last 98% pure copper (Cu). In yet other approaches, the metal foam may include a combination of metals.

### IN USE

Various embodiment described herein are useful for application as nanostructured catalysts and NIF targets. Furthermore, application of other metals to the embodiments described herein may lead to additively manufacturing high energy density (HED) materials and thermite.

Application of the various embodiments described herein include conductive inks, solar cells, battery electrolytes, transparent conductors, electronic devices, thermoelectrics, drug delivery, and biocompatible scaffolds.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method of forming a metal foam with substantially uniform density, the method comprising:
forming a metallopolymer network comprising metallopolymer material with pre-defined ionic conductivity and pre-defined polymeric chain length;
adding a reductant to the metallopolymer network during formation thereof for creating metal nanoparticles in the metallopolymer network, wherein the metal nanoparticles have substantially uniform size; and
heating the reduced metallopolymer network for sintering the metal nanoparticles into a network.

2. The method as recited in claim 1, wherein the metallopolymer material comprises a metal, a thiol, and a glyme, wherein a molar ratio of the thiol to the metal is at least 3:1, wherein a molar ratio of the glyme to the metal is at least 6:1.

3. The method as recited in claim 2, wherein a length of a polymeric side chain of the thiol determines the metal nanoparticle spacing in the reduced metallopolymer network.

4. The method as recited in claim 2, wherein the thiol is selected from the group consisting of: glutathione, cysteine, and thiomalic acid.

5. The method as recited in claim 1, wherein the formed metallopolymer network is electrically conductive.

6. The method as recited in claim 1, wherein the formed metallopolymer network is a printed three dimensional structure.

7. The method as recited in claim 1, further comprising controlling a concentration of a reductant to result in a particular diameter of metal nanoparticles in the reduced metallopolymer network.

8. A method of forming a metal foam with graded density, the method comprising:
forming a metallopolymer network comprising metallopolymer material with pre-defined ionic conductivity and pre-defined polymeric chain length;
reducing the formed metallopolymer network to form metal nanoparticles therein, wherein the reduced metallopolymer network has a graded size density of metal nanoparticles therein; and
heating the reduced metallopolymer network for sintering the metal nanoparticles into a network.

9. The method as recited in claim 8, wherein the metallopolymer material comprises a metal, a thiol, wherein a molar ratio of the thiol to the metal is at least three, and a glyme, wherein a molar ratio of the glyme to the metal is at least 6:1.

10. The method as recited in claim 9, wherein the thiol is selected from the group consisting of: glutathione, cysteine, and thiomalic acid.

11. The method as recited in claim 8, wherein the formed metallopolymer network is electrically conductive.

12. The method as recited in claim 8, wherein the metallopolymer network is formed by printing an ink, the ink comprising the metallopolymer material, wherein the formed metallopolymer network is a printed three dimensional structure.

13. A metal foam, comprising,
a nanoporous metal structure, wherein the nanoporous metal structure has physical characteristics of formation in part by three dimensional printing of an ink.

14. The metal foam as recited in claim 13, wherein the metal foam has a graded density with an average porosity increasing from an outer surface of the metal foam toward an innermost portion thereof.

15. The metal foam as recited in claim 13, wherein the metal foam has a substantially uniform density throughout.

16. The metal foam as recited in claim 15, wherein the metal foam has substantially uniform spacing throughout.

17. The metal foam as recited in claim 15, wherein the metal foam have substantially uniform porosity.

18. The metal foam as recited in claim 13, wherein a physical characteristic of formation by three dimensional printing includes ridges along one surface of the metal foam.

19. The metal foam as recited in claim 13, wherein the nanoporous metal structure has pores with a diameter of nanometer scale.

20. The metal foam as recited in claim 13, wherein the metal foam comprises at least one coinage metal selected from the group consisting of: at least 98% pure gold, at least 98% pure copper, and at least 98% pure silver.
